(19) United States
(12) Patent Application Publication
(10) Pub. No.: US 2026/0362069 A1
(43) Pub. Date: Nov. 12, 2026

(54) BACK-VENTING EARPIECE

(71) Applicant: WIDEX A/S, Lynge (DK)

(72) Inventors: Lars FRIIS, Vaerloese (DK); Patrick SCHEEPER, Naerum (DK); Klaus Henrik VAARBROE, Skovlunde (DK)

(73) Assignee: WIDEX A/S, Lynge (DK)

(21) Appl. No.: 19/123,251

(22) PCT Filed: Oct. 25, 2023
(86) PCT No.: PCT/EP2023/079815

§ 371 Date: Apr. 22, 2025

(30) Foreign Application Priority Data
Oct. 28, 2022 (DK) PA202270522

(51) Int. Cl. H04R 25/00

(52) U.S. Cl. CPC H04R 25/604; H04R 25/505; H04R 25/652; H04R 25/658; H04R 2225/023

(57) ABSTRACT

A hearing aid earpiece (10) is provided. The hearing aid earpiece (10) is arrangeable within an ear canal (12) of a user and comprises: a shell (20) enclosing a fixed back-vent volume (22) of fluid; and a receiver (30) comprising a back volume (32) and a front volume (36) separated by an acoustic membrane (34), which is configured to use the back volume (32) to produce an acoustic output in the front volume (36) that is directed towards an interior of the ear canal (12); wherein the receiver (30) further comprises a back-vent (38) to fluidly connect the back volume (32) with the back-vent volume (22).

A hearing aid (50) comprising such a hearing aid earpiece (10) and a method of manufacturing a hearing aid earpiece are further provided.

### TECHNICAL FIELD

The present inventive concept relates to a hearing aid earpiece. More specifically, the present inventive concept relates to a hearing aid earpiece comprising a back-vent, a method for manufacturing such and a hearing aid comprising such.

### BACKGROUND

Hearing aids are generally constrained by size in different ways. Any part outside the ear should be comfortable and aesthetically pleasing, so they cannot be too large or bulky. Any part inside the ear is limited by the size of the user's ear canal, which varies but generally puts constraints on the design and functionality of hearing aids.

One such constraint is that any receiver placed at least partially in the ear canal of a user must be relatively small, and thereby make do with a relatively small volume to produce sound with. The higher output level that a receiver is able to produce, the more users may be helped by the hearing aid. However, the output level is limited by the size of the receiver, partially due to the small volume of air available to it.

### SUMMARY

It is thereby an object of the present inventive concept to make better use of the relatively small volume available to the receiver to improve the output of the receiver. This and other objects are achieved by the features set out in the appended independent claims, with embodiments set out in the dependent claims.

Accordingly, a first aspect of the inventive concept being a hearing aid earpiece arrangeable within an ear canal of a user is provided. The hearing aid earpiece comprises: a shell enclosing a fixed back-vent volume of fluid; and a receiver comprising a back volume and a front volume separated by an acoustic membrane, which is configured to use the back volume to produce an acoustic output in the front volume that is directed towards an interior of the ear canal; wherein the back-vent volume comprises the receiver, and the receiver further comprises a back-vent to fluidly connect the back volume with the back-vent volume.

A hearing aid earpiece is a component intended to be worn in the ear of a user to deliver output audio to the user. The earpiece may be completely in canal (CIC) or be fitted near the outer edge of the ear canal and partially extend outside the ear canal. The earpiece may be custom fitted to the user's ear and may or may not comprise other parts of a hearing aid such as a microphone.

In a specific type of Receiver-In-The-Ear (RITE) hearing aids, the receiver is placed inside the ear canal. This category is sometimes referred to as Receiver-In-Canal (RIC) hearing aids. In-The-Ear (ITE) hearing aids are designed for arrangement in the ear, normally in the funnel-shaped outer part of the ear canal. In a specific type of ITE hearing aids the hearing aid is placed substantially inside the ear canal. This category is sometimes referred to as Completely-In-Canal (CIC) hearing aids or Invisible-In-Canal (IIC). This type of hearing aid requires an especially compact design in order to allow it to be arranged in the ear canal, while accommodating the components necessary for operation of the hearing aid.

The receiver is a speaker configured to receive an electrical audio signal from other parts of the hearing aid and output this signal as sound to the user.

The interior of the ear canal is the part of the ear canal that houses the ear drum.

The shell enclosing a fixed back-vent volume of fluid may be hermetically sealed, and the fluid may be gaseous or liquid, such as air.

The volume of fluid being fixed means that the volume is not open to the outside, e.g. through a ventilation opening or pressure equalization vent. The volume of fluid being fixed further means that shell is not compressible by outside force, the shell rigidly defines a volume that is the same throughout the lifetime of the hearing aid earpiece.

By fluidly connecting the back volume with the back-vent volume, the back volume is effectively increased, thereby reducing the air stiffness and increasing output volume.

According to an embodiment, the fixed back-vent volume is at least 10 mm³. The fixed back-vent volume being at least 10 mm³ enables the effective increase of the back volume to be proportionally large enough to create a relevant increase of the output volume. The fixed back-vent volume may be between 80 mm³ and 120 mm³, such as around 100 mm³. The fixed back-vent volume may also be 200 mm³ to 300 mm³. The fixed back-vent volume may be different for each user's ear, depending on the size of the ear canal.

According to an embodiment, one dimension of the fixed back-vent volume is the same length as a corresponding dimension of the receiver. According to a further embodiment, exactly one dimension of the fixed back-vent volume is the same length as a corresponding dimension of the receiver.

By fitting a dimension of the back-vent volume to a corresponding dimension of the receiver, the receiver may be easier to fit in the shell. An extension of the back-vent volume in the remaining dimensions beyond the size of the receiver may be considered to define the usable back-vent volume.

This dimension may e.g. be the length, i.e. the dimension that extends along the extension of the ear canal, e.g. from the exterior to the interior of the ear canal. In this case the length of the fixed back-vent volume is the same as the length of the receiver.

At least one of the remaining two dimensions of the fixed back-vent volume are larger than the corresponding dimension of the receiver. This is what defines the usable back-vent volume.

By choosing exactly one dimension to be the same length, the receiver may be made as large as possible in the dimension that most benefits its acoustic output while compromising as little as possible on the size of the back-vent volume.

The precise choice of the fixed back-vent volume may depend on a balance between a volume small enough to fit most users and a volume large enough to make a noticeable impact on the output level. The impact that the back-vent volume has on the output level is proportional to the size of the receiver and this relation may be plotted as a curve that plateaus at a certain volume. This plateau volume may be chosen as the fixed back-vent volume.

According to an embodiment, the shell further comprises a groove adapted to receive the (tip of the) receiver.

This improves a seal of the back-vent volume and simplifies manufacturing. This also makes manufacturing more reliable and consistent due to self-alignment of the receiver in the shell.

The groove may be an indentation in a wall of the shell shaped as an inverse of an abutting end (the tip) of the receiver, such that the receiver forms a sealing interface with the groove. The groove may serve dual purpose, both to ensure that the receiver engages with the earpiece shell to fluidly seal the back-vent volume and to aid the insertion of the receiver so that it is correctly inserted into (and self-aligned with) the earpiece.

According to an embodiment, the shell further comprises a connector for electrically connecting the receiver to a hearing aid device.

The hearing aid device comprises a microphone configured to detect sound and convert it to an electrical signal, which may involve processing of the detected audio, which electrical signal is sent to the receiver of the earpiece via the connector. The connector may be wired or wireless.

According to an embodiment, the receiver is directly attached to the shell.

Directly attached may mean that the receiver is fixedly attached to the shell, e.g. using an adhesive. The receiver is thereby not suspended in rubber.

This further optimizes the space in the shell to make the best possible use of the back-vent volume. This is because there's no intermediary between the receiver and the shell, and the shell may thereby be molded to optimize the back-vent volume while still ensuring the receiver fits.

Additionally, the performance of the hearing aid will be more consistent with a fixedly attached receiver, which in turn makes the hearing aid easier to optimize and more reliable.

According to an embodiment, the shell comprises a faceplate that functions as a backplate for the receiver.

By functioning as a backplate, the faceplate seals the earpiece from sounds and fluids.

The faceplate may be an integrated part of a plastic mold of the shell, enclosing the volume within the ear canal of the user. The faceplate may be custom molded for the shape of the ear.

According to an embodiment, the faceplate is at least 2 mm thick.

The faceplate may further be at least 2.2 mm thick. The thickness of the faceplate may depend on the receiver. Such a thickness may facilitate a hermetic seal of the shell and further facilitate a sufficient auditory isolation of the back-vent volume. In an embodiment where the faceplate comprises a microphone, such auditory isolation may be especially important to reduce feedback.

It is noted that walls of the shell that are not the faceplate, i.e. the walls not facing the exterior of the ear canal, may also function as a backplate. However, these walls may be thinner than the faceplate, e.g. between 0.5-2 mm such as 1 mm, as these parts of the shell may be less exposed to external sounds.

According to an embodiment, the shell is configured to be fitted completely in the ear canal of the user.

The inventive concept is well-suited to a shell being fitted completely in the ear canal of the user. This is because the back-vent volume is thereby easier to seal and control, and the size limitations inherent to such an earpiece also result in a relatively higher impact by the inventive concept in that a relatively small back-vent volume may still enable a percentually large increase of the back volume.

According to an embodiment, the shell is custom fitted to the ear canal of the user.

Such a custom fit may optimize the available back-vent volume and a user needing a custom fit may also be helped more by the inventive concept due to usually having a bigger hearing impairment than a non-custom fit of a corresponding size and hence benefitting more from a higher output level.

According to an embodiment, the shell is made of UV resin.

The UV resin may be hard and/or soft. Such a material has good acoustic characteristics to not transmit the vibrations in the hearing aid earpiece into the ear canal.

A stiffness of the material, such as with hard UV resin, may further maintain the integrity of the shell for the purpose of maintaining the back-vent volume.

The shell may further act as an acoustic spring, and a smart choice of shell material may reduce a spring constant compared to the stiffness of the receiver.

A second aspect of the inventive concept is a hearing aid. The hearing aid comprises: a microphone for converting external sounds into an electrical signal; a signal processor for processing the signal produced by the microphone to produce a hearing-loss compensating electrical signal; and the hearing aid earpiece according to the first aspect, configured to receive the hearing-loss compensating electrical signal and produce a hearing-loss compensating sound signal using the receiver.

Such a hearing aid may have all the benefits and embodiments of the first aspect.

According to an embodiment, the hearing aid is a receiver-in-canal (RIC)-type hearing aid.

Such a hearing aid is especially suited for the present inventive concept, as the size limitations inherent to such a hearing aid also result in a relatively higher impact by the inventive concept.

A third aspect of the inventive concept is a method of manufacturing a hearing aid earpiece. The method comprises steps of: forming an earpiece shell comprising a groove on a first end of a fixed back-vent volume adaped to hold fluid, the groove being fluidly connected to an output of the earpiece and a receiver-shaped opening on a second end of the back-vent volume adapted to hold fluid opposite the first end; inserting a receiver, the receiver comprising a back volume and a back-vent to fluidly connect the back volume with the back-vent volume and having a length being the same as a distance between the groove and the receiver-shaped opening, through the opening such that the receiver abuts the groove; and sealing the opening by applying a sealant to the receiver.

The sealant may be resin, such as UV resin, or any other suitable adhesive. The step of applying a sealant may comprise UV-treating the sealant to harden it.

The groove may be an indentation in a wall of the earpiece shell shaped as an inverse of the abutting end of the receiver, such that as the receiver is inserted the receiver forms a sealing interface with the groove. The groove may serve dual purpose, both to ensure that the receiver engages with the earpiece shell to fluidly seal the back-vent volume and to aid the insertion of the receiver so that it is correctly inserted into the earpiece.

According to an embodiment, the step of forming the shell further comprises adapting the outer shape of the shell to match an ear canal of a user.

Such a step may make better use of the available back-vent volume and result in a more comfortable earpiece.

According to an embodiment, the method further comprises a step of applying a sealant to an end of the receiver adapted to abut the groove before inserting the receiver.

This sealant may be the same or a different one than the one used for sealing the opening. By applying a sealant to the end of the receiver adapted to abut the groove, the volume may be more securely sealed.

### DESCRIPTION OF DRAWINGS

The invention will be described in further detail with reference to preferred embodiments and the accompanying drawings, in which:

FIG. 1a shows a schematic view of a hearing aid earpiece according to an embodiment;

FIG. 1b shows a more realistic view of a hearing aid earpiece according to an embodiment;

FIG. 2 shows a schematic view of a hearing aid according to an embodiment; and

FIG. 3 shows a flowchart of a method of manufacturing a hearing aid earpiece according to an embodiment.

### DESCRIPTION OF EMBODIMENTS

In the following, terms such as a/an/the and comprising are intended to be interpreted as non-limiting. Any processor or computing unit may be implemented as an electronic circuit and electronic connections may be wired or wireless unless otherwise explicitly stated. Unless explicitly specified, a wireless connection may be implemented in any number of standards known to a person skilled in the art, such as Wi-Fi, Bluetooth®, Zigbee, 4G/LTE, 5G and so on.

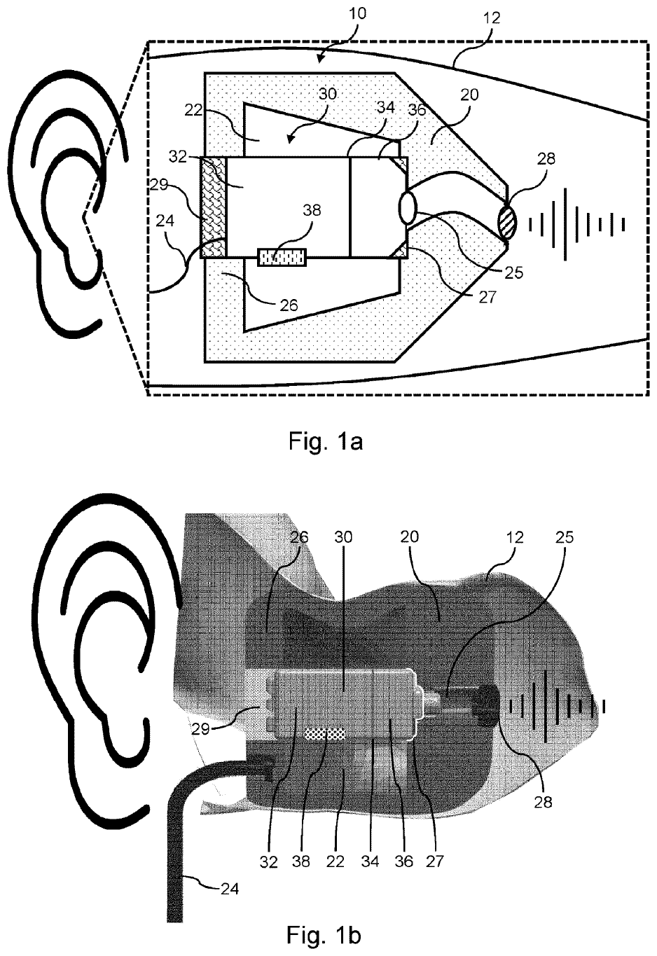

FIG. 1a shows an embodiment of a hearing aid earpiece 10. The earpiece comprises a shell 20 enclosing a fixed back-vent volume 22 of fluid and a receiver 30.

The shell 20 may be made of hard or soft UV resin or plastic. The shell 20 may be configured to be fitted completely in the ear canal 12 of the user and/or custom shaped to fit in an ear canal 12 of a user. The shell 20 and back-vent volume 22 may be formed by using 3D-printing techniques.

The shell 20 may be formed under a relatively great degree of control and may be relatively straightforward to seal.

The shell 20 further comprises a connector 24 for electrically connecting the receiver 30 to a hearing aid device. The connector 24 may be configured to receive wired and/or wireless electrical signals.

The back-vent volume 22 is at least 10 mm³ and may be proportional to a size of the receiver 30. The back-vent volume 22 may have one dimension adapted to be the same size as a dimension of the receiver 30. This dimension of the receiver 30 may be its length, being its longest dimension in FIG. 1a, and/or be in a same or similar direction that the receiver 30 is adapted to output sound in.

The shell 20 may have walls being at least 1 mm thick. Furthermore, the wall of the shell 20 facing towards an exterior of the ear canal 12 may be at least 2 mm thick. This additional thickness enables a better acoustic isolation towards the most probable and intense source direction of sound, thereby reducing feedback.

The receiver 30 comprises a back volume 32 and a front volume 36 separated by an acoustic membrane 34. The acoustic membrane 34 is configured to use the back volume 32 to produce an acoustic output in the front volume 36 that is directed towards an interior of the ear canal 12.

The output of the receiver 30 may be fluidly connected to the interior of the ear canal 12, e.g. through an opening 25 in the shell 20 leading to an output of the earpiece 10. This opening 25 in the shell 20 may be separate from the back-vent volume 22 and may be sealed from the back-vent volume 22 by the receiver 30. This opening 25 may comprise a wax guard 28 to protect the receiver 30 from ear wax.

The receiver 30 further comprises a back-vent 38 to fluidly connect the back volume 32 with the back-vent volume 22. By fluidly connecting the back volume 32 with the back-vent volume 22, the back volume 32 is effectively increased, thereby reducing the air stiffness and increasing output volume of the receiver 30.

The receiver 30 in FIG. 1a is directly attached to the shell 20. The receiver 30 may be glued to the shell 20 to fixedly attach the receiver 30 to the shell 20.

The shell 20 may comprise a groove 27 adapted to receive the receiver 30, e.g. by having a shape matching an end of the receiver 30. The receiver 30 may abut the groove 27.

The groove 27 may be fluidly connected to an output of the earpiece 10 and may comprise an opening 25 in the shell 20. The groove 27 may facilitate attaching the receiver 30 to the shell 20 and aligning the receiver 30 in the back-vent volume 22, with the output of the earpiece 10 and/or with an opening 29 for inserting the receiver 30 into the shell 20 during manufacturing.

The back-vent volume 22 in FIG. 1a is sealed at either end of the receiver 30. At the end towards the interior of the ear canal 12, the receiver 30 seals the opening (also known as sound bore) 25 leading to an output of the earpiece 10. At the end towards the exterior of the ear canal 12, the receiver seals the opening 29 for inserting the receiver 30 into the shell 20 during manufacturing. The seal of this opening 29 may comprise an adhesive or resin applied to and/or around a back end of the receiver 30 to hermetically seal the back-vent volume 22.

Preferably, the receiver 30 matches the same size and shape as the opening 29 for inserting the receiver 30 into the shell 20, as this simplifies the sealing of the opening 29.

In an alternative embodiment, the shell 20 further comprises a sealing plug (not shown) that is attached across the opening 29 for inserting the receiver 30 into the shell 20 to seal said opening 29.

The back of the shell 20, facing towards the outside end of the ear canal, may be considered a faceplate 26. The faceplate 26 may function as a backplate for the receiver 30. Thereby, the faceplate 26 may acoustically and hermetically seal the back-vent volume 22.

The faceplate 26 may be made of hard plastic, resin and/or metal and may be at least 2 mm thick. The faceplate 26 may be formed to be acoustically insulating.

FIG. 1b shows a similar hearing aid earpiece 10 as in FIG. 1a, in a more realistic view.

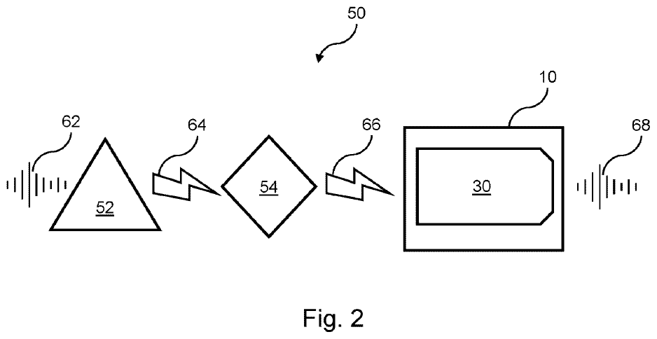

FIG. 2 shows an embodiment of a hearing aid 50. The hearing aid 50 comprises a microphone 52, a signal processor 54, and a hearing aid earpiece 10. The hearing aid earpiece 10 may be a hearing aid earpiece 10 as described in relation to FIGS. 1a-b.

The microphone 52 is configured to convert external sounds 62 into an electrical signal 64.

The signal processor 54 is configured to process the electrical signal 64 produced by the microphone 52 to produce a hearing-loss compensating electrical signal 66. This processing may e.g. comprise filtering such as noise filtering and directional compensation.

The hearing aid earpiece 10 is configured to receive the hearing-loss compensating electrical signal 66 and produce a hearing-loss compensating sound signal 68 in the receiver 30.

The hearing aid 50 may be a receiver-in-canal (RIC) type hearing aid.

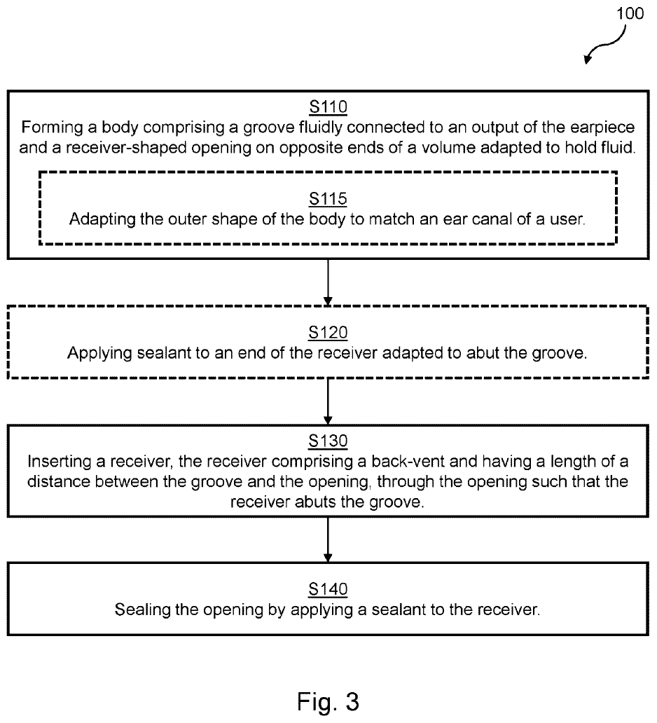

FIG. 3 shows a method 100 for manufacturing a hearing aid earpiece. The hearing aid earpiece may e.g. be the hearing aid earpiece as in FIGS. 1a-b.

The method 100 comprises a number of steps S110-S140 performed in a specific order, some of which are optional. The optional steps are shown in FIG. 3 as boxes with dotted lines.

The first step S110 comprises forming a shell. The shell is formed S110 comprising a groove fluidly connected to an output of the earpiece and a receiver-shaped opening on opposite ends of a volume adapted to hold fluid. This step S110 may be performed e.g. by extrusion, injection moulding, or 3D-printing.

The shell may be shaped to receive a specific receiver. This may comprise forming the groove to receive and abut the receiver, e.g. by having a complementary shape of an end of the receiver adapted to abut the groove.

This may further comprise forming a receiver-shaped opening that leaves relatively little room once the receiver is inserted, such that it may be more reliably and easily sealed. This further prevents sealing material leaking into the volume adapted to hold fluid, thereby maintaining the volume adapted to hold fluid and protecting the receiver.

The step S110 of forming the shell may further comprise adapting S115 the outer shape of the shell to match an ear canal of a user. The shape of the ear canal of the user may e.g. be moulded and computer modelling may be used to create an inverted shape to match the shape of the ear canal.

A next step S120 comprises optionally applying sealant to the end of the receiver adapted to abut the groove. This may improve a seal of the volume adapted to hold fluid.

A next step S130 comprises inserting a receiver, the receiver comprising a back-vent and having a length of a distance between the groove and the receiver-shaped opening, through the receiver-shaped opening such that the receiver abuts the groove. The receiver will thereby be aligned with the shell to improve the seal of the volume adapted to hold fluid.

A final step S140 comprises sealing the opening by applying a sealant to the receiver. The sealant may be resin, such as UV resin, or any other suitable adhesive.

The step S140 of applying a sealant may comprise UV-treating the sealant to harden it. The shell may be transparent, translucent or semi-transparent, thereby allowing UV light to reach any sealant at the groove. The UV light may regardless penetrate the shell to reach any sealant at the groove.

The preceding description has been a non-exhaustive disclosure of different exemplifying embodiments of the present inventive concept. This is not to be misconstrued as limiting the scope of the protection sought for the inventive concept, which is defined by the appended claims.

1. A hearing aid earpiece arrangeable within an ear canal of a user, the hearing aid earpiece comprising:
a shell enclosing a fixed back-vent volume of fluid; and
a receiver comprising a back volume and a front volume separated by an acoustic membrane, which is configured to use the back volume to produce an acoustic output in the front volume that is directed towards an interior of the ear canal;
wherein the back-vent volume comprises the receiver and the receiver further comprises a back-vent to fluidly connect the back volume with the back-vent volume.

2. The hearing aid earpiece according to claim 1, wherein the fixed back-vent volume is at least 10 mm³.

3. The hearing aid earpiece according to claim 1, wherein one dimension of the fixed back-vent volume is the same length as a corresponding dimension of the receiver

4. The hearing air earpiece according to claim 1, wherein the shell further comprises a groove adapted to receive the receiver.

5. The hearing air earpiece according to claim 1, wherein the receiver is directly attached to the shell.

6. The hearing aid earpiece according to claim 1, wherein the shell comprises a faceplate that functions as a backplate for the receiver.

7. The hearing air earpiece according to claim 6, wherein the faceplate is at least 2 mm thick.

8. The hearing aid earpiece according to claim 1, wherein the shell is configured to be fitted completely in the ear canal of the user.

9. The hearing air earpiece according to claim 8, wherein the shell is custom fitted to the ear canal of the user.

10. The hearing air earpiece according to claim 8, wherein the shell is made of hard or soft UV resin.

11. A hearing aid comprising:
a microphone for converting external sounds into an electrical signal;
a signal processor for processing the electrical signal produced by the microphone to produce a hearing-loss compensating electrical signal; and
the hearing aid earpiece according to claim 1, configured to receive the hearing-loss compensating electrical signal and produce a hearing-loss compensating sound signal using the receiver.

12. The hearing aid according to claim 11, wherein the hearing aid is a receiver-in-canal, RIC, type hearing aid.

13. A method of manufacturing a hearing aid earpiece, the method comprising steps of:
forming a shell comprising a groove fluidly connected to an output of the earpiece and a receiver-shaped opening on opposite ends of a volume adapted to hold fluid;
inserting a receiver, the receiver comprising a back-vent and having a length being the same as a distance between the groove and the receiver-shaped opening, through the opening such that the receiver abuts the groove; and
sealing the opening by applying a sealant to the receiver.

14. The method of claim 13, wherein the step of forming the shell further comprises adapting the outer shape of the shell to match an ear canal of a user.

15. The method of claim 13, further comprising a step of applying a sealant to an end of the receiver adapted to abut the groove before inserting the receiver.
